(19) United States
(12) Patent Application Publication
(10) Pub. No.: US 2022/0344923 A1
(43) Pub. Date: Oct. 27, 2022

(54) A COMBINED CABLE TROUGH AND WALKWAY

(71) Applicant: TROJAN SERVICES LIMITED, Hove (GB)

(72) Inventor: Stewart WELLENS, Hove (GB)

(21) Appl. No.: 17/596,590

(22) PCT Filed: Jun. 14, 2019
(86) PCT No.: PCT/GB2019/051649

§ 371 Date: Dec. 14, 2021

(51) Int. Cl. H02G 9/04; E01B 2/00

(52) U.S. Cl. CPC H02G 9/04; E01B 2/00

(57) ABSTRACT

Disclosed is a trunking section for carrying cables, wherein the trunking section comprises mutually interlocking parts allowing two trunking sections to be semi-permanently connected together, wherein the trunking section comprises means to receive at least one divider to partition an interior of the trunking section into at least two longitudinal channels, separated by the at least one divider.

The present invention concerns a combined cable trough, or trunking section, and walkway for use primarily in a railway environment for routing and carrying communication and/or power cables and which also has a function as a safe level walkway beside a railway track.

Railway tracks are frequently laid on uneven ground which has been topped off with ballast, which is essentially rubble. When railway technicians and engineers are required to work on the railway, they often have to walk significant distances alongside the railway track over this ground. The unevenness of this ground poses a problem for the workers and makes it difficult to transport tools and equipment if there is no corresponding access roadway.

Additionally, railway tracks, often in urban settings, are laid into roadways (for light rail or tram applications) or laid on elevated sections, above roads and other traffic.

There are often regulations in place that dictate certain requirements for provision of a safe and level walkway alongside railway tracks. Currently, such walkways tend to consist of flattened and compressed earth and are not generally suitable to transport tools and equipment. In wet weather, such walkways can become slippery and dangerous.

At the same time, there is often a requirement to provide routing for cables alongside railway tracks. These cables can be used for transmitting power around the railway network, or for signalling and communication purposes. Sometimes, third parties lease space in the routing system and make use of the extensive railway network to route their own communication cables around the country.

Accordingly, there is a need to provide a system for implementing walkways to run alongside railway tracks in a quick, easy and economic manner, which can be easily retrofitted to existing railway infrastructure.

Embodiments of the present invention aim to address problems in the prior art, and other problems whether mentioned explicitly herein or not.

According to a first aspect of the present invention, there is provided a trunking section for carrying cables, wherein the trunking section comprises mutually interlocking parts allowing two trunking sections to be semi-permanently connected together, wherein the trunking section comprises means to receive at least one divider to partition an interior of the trunking section into at least two longitudinal channels, separated by the at least one divider.

In an embodiment, there is further provided a divider.

In an embodiment, there is further provided two dividers, arranged to partition the interior of the trunking section into three longitudinal channels.

In an embodiment, the at least one divider is substantially planar and provided with a part which is arranged to have an interference fit with the means to receive at least one divider, and so hold the at least one divider in place.

In an embodiment, a lap joint is formed between adjacent sidewalls of connected trunking sections.

In an embodiment, the trunking section comprises a plurality of feet extending from a lower surface of the trunking section.

In an embodiment, there is further provided a lid arranged to close the trunking section.

In an embodiment, the lid is provided with a plurality of fastening apertures to accommodate fasteners to secure the lid to the trunking section.

In an embodiment, the lid is provided with a substantially non-slip surface.

In an embodiment, the trunking section is unitary and formed from a plastics material in an injection moulding process.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

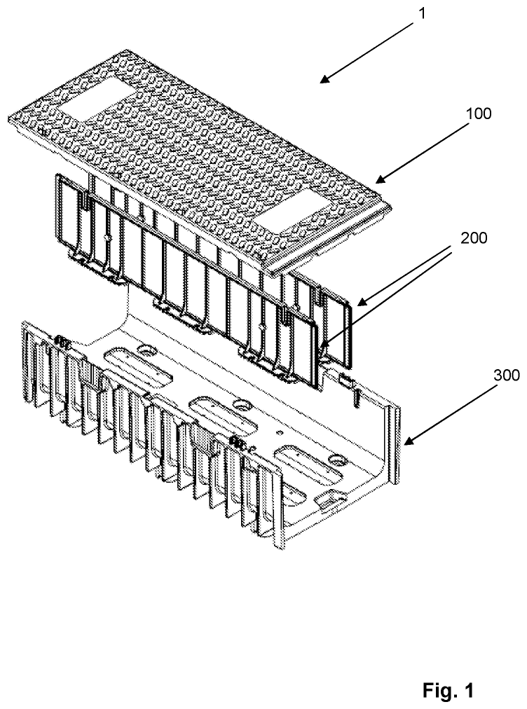

FIG. 1 shows a perspective exploded view of an embodiment of the invention;

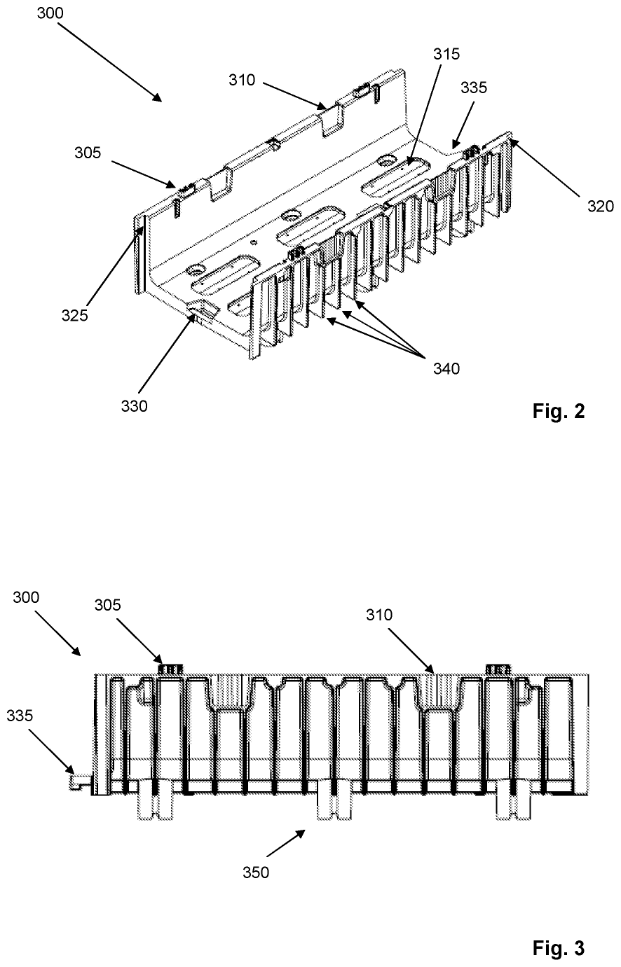

FIG. 2 shows a perspective view of a trough element of an embodiment of the present invention;

FIG. 3 shows a side view of a trough element of an embodiment of the present invention;

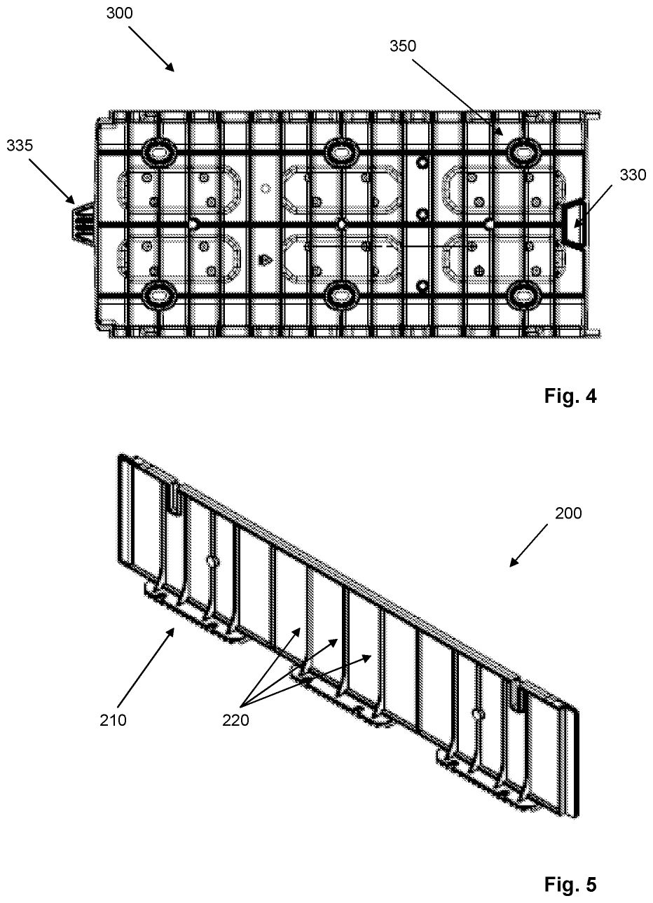

FIG. 4 shows an underside view of a trough element of an embodiment of the present invention;

FIG. 5 shows a perspective view of a divider element of an embodiment of the present invention;

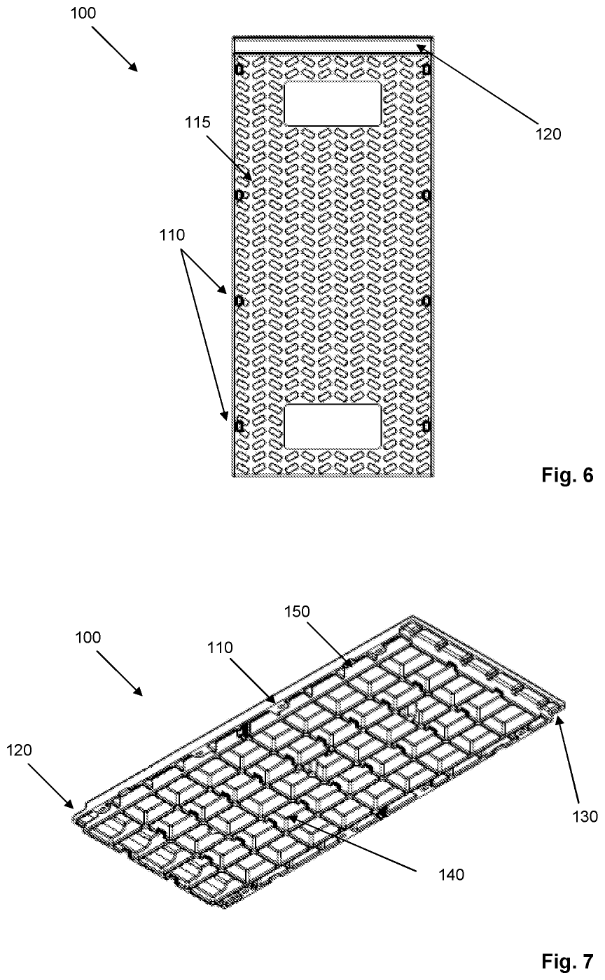

FIG. 6 shows a top plan view of a lid of an embodiment of the present invention;

FIG. 7 shows an underside perspective view of a lid of an embodiment of the present invention;

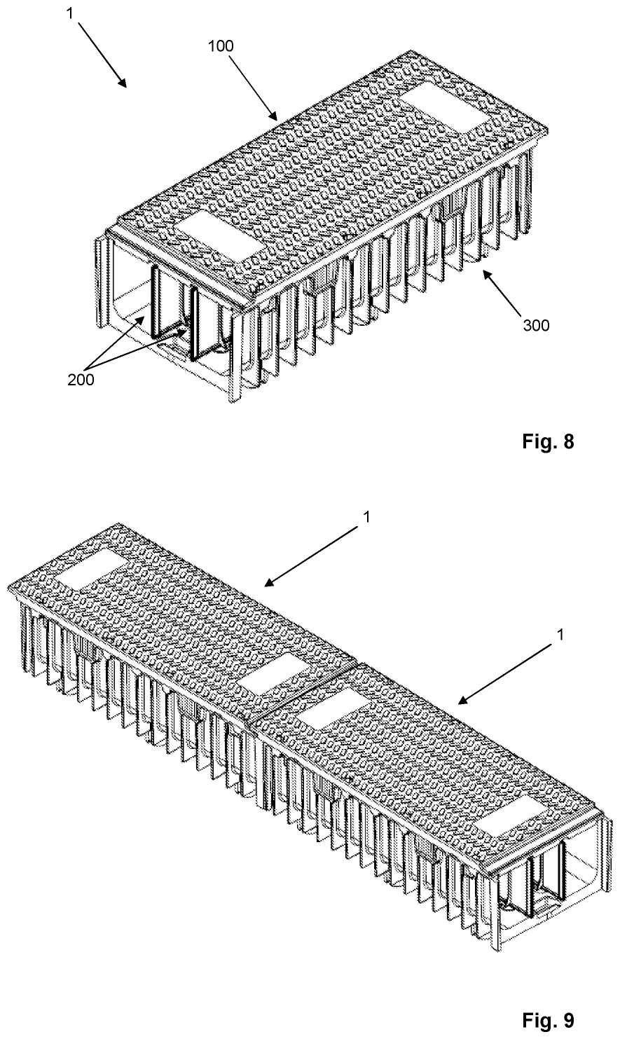

FIG. 8 shows a perspective view of an assembled unit according to an embodiment of the present invention; and

FIG. 9 shows two of the units of FIG. 8 connected together in use.

FIG. 1 shows a perspective view of an assembly or unit 1, comprising a trough 300 together with lid 100. The trough is provided with two dividers 200. The trough 300 arranged in use to be wholly or partially buried alongside a railway track. Alternatively, it can be arranged to stand proud of its supporting surface in certain implementations. The trough 300 is generally U-shaped and, in use, a plurality of such troughs 300 are arranged end to end to carry cables associated with the railway system or otherwise.

These may be power cables, signalling cables, data communication cables or cables carried for third parties, such as fibre-optic data cables.

The cable trough 300 is constructed from a plastics material. The plastics material comprises a polymer which is preferably recycled. In a preferred embodiment the preferred polymer is a polyolefin. The trough component 300 is preferably constructed using an injection moulding process as a single component. By use of a plastics material, the weight of the trough or trunking section is kept at a level where it may be carried by a single person, greatly easing work with the units on-site

The other components, so be described in more detail later, are also constructed from the same materials, using the same injection moulding process.

The generally U-shaped channel formed by the trough 300 is shown in FIG. 2. The channel is formed by a base and two generally upright sidewalls, which are each provided with a plurality of reinforcing ribs 340. These are arranged externally and extend from the trough. As well as providing additional rigidity, the ribs 340 assist in anchoring the trough 300 in the ground, if it is installed in a scenario where it is at least partially buried, either in earth, gravel or hardcore.

Along an upper edge of each sidewall is at least one lid-engaging projection 305. These are arranged to engage with a complementary recess in the lid 100.

Located towards an upper portion of each sidewall is at least one knockout panel 310. This is arranged so that cables running in the trough can be provided with an exit to couple to trackside equipment or to another conduit for onward transmission elsewhere. The knockout panel 310 is arranged to have a thickness somewhat less that the surrounding material such that it can be removed with e.g. a hammer blow or by use of a pair of snips.

The base of the trough 300 is provided with a plurality of recesses 315 arranged to receive a divider 200, so be described later.

In order to connect two troughs 300 end to end, as required to create a suitable length of troughing, there are two distinct features of the trough 300 which facilitate this. Note that in practice, many hundreds or thousands of troughs 300 may form an installation.

At opposed end of the trough are coupling projection 335 and coupling receiver 330. Coupling projection 335 may be considered as a male part and coupling receiver 330 may be considered as a female part. As such, the troughs may only be joined in one orientation, male to female.

The male 335 and female 330 parts interconnect snugly, but allow a small amount of relative rotation therebetween (just a few degrees) to accommodate bends in the track along which the troughs are fitted.

In addition to the male 335 and female parts, the exposed ends of the sidewalls 320, 325 assume a form of lap joint. In other words, the end of the trough with the coupling projection 335, has exposed sidewall ends 320 which inter-engage with the exposed sidewall ends 325 of the opposed end such that a form of lap joint is created and thereby access to an interior of the trough is not permitted once the lid is fitted, due to the overlapping of the portions 320, 325.

In FIG. 3, which shows a side view of the trough 300, the coupling projection 335 can be clearly seen extending from the left had side, as shown. Also visible in this view are the plurality of supporting feet 350. In this particular embodiment, six such feet are provided as two rows of three. This can be more clearly seen in the underside view of FIG. 4.

These feet can provide further anchoring if the trough 300 is planted or buried in use. In an alternative use scenario, the troughs 300 may be provided on a relatively hard, level surface, such as an elevated structure carrying the railway, where the supporting surface is concrete. In such a case, the feet 350 serve to raise the troughs 300 slightly above this surface. That can be helpful in keeping the ingress of water to a minimum and/or allowing any water which does enter the troughs to drain away through the base of the trough.

The troughs can be fastened to the supporting surface by applying a suitable fastener, such as a screw of bolt through the foot 350 from the interior of the trough 300.

FIG. 5 shows a view of a divider 200 arranged to be fitted to trough 300. In the embodiment shown in FIG. 1, two such dividers 200 are provided, which divide the interior of the trough longitudinally into three channels. More or fewer such dividers 200 may be provided as required, and with corresponding changes to the trough 300 to accommodate them.

The divider 200 is a substantially planar element having substantially the same height as the depth of trough 300, so that it runs from the bottom to the top of the trough 300. At a lower edge thereof is provided a plurality of pads 210 arranged to couple with recesses 315 in the trough. The pad 210 is arranged to have an interference fit with recess 315 so that it may be simply pushed into position, ready for use. The divider 200 is not required to have great mechanical strength, since it is not bearing any weight. However, it is provided with a plurality of substantially vertical ribs 220 to provide rigidity.

FIG. 6 shows a lid 100 for fitting to trough 300. It is generally planar and is arranged to have substantially the same dimensions as the upper part of the trough 300, so as to close the trough, when fitted.

The upper surface is provided with a plurality of grip features 115 which provide a substantially non-slip upper surface when the lid 100 is used as a walkway. The grip features 115 may be formed in the moulding process as a series of small projections.

Provided along each long side of the lid 100 are a plurality of coupling apertures 110. These are arranged to lie above complementary fastening receivers in the trough sidewalls. A screw or bolt is fitted through each aperture 110 and engages with the complementary recess to fasten the lid in place. The screw or bolt may be provided in the form of a security screw or bolt having a non-common head such that a special tool is required to fit or remove it. This can provide extra security and deter interference with the contents of the trunking section.

Each short end of the lid is provided with complementary fittings such that the lid 100 can only be fitted in one orientation such that a lap joint is formed, in much the same way as described previously in respect of the ends of troughs 300. Features 120 and 130 are best viewed in FIG. 7.

FIG. 7 also shows the matrix-like structure 140 on the underside of the lid 100. This matrix 140 takes the form of perpendicular intersecting ribs, which extend from the underside of the lid and provide mechanical strength to the lid, which should be able to withstand the weight of at least a person walking thereon and preferably the weight of tools or equipment also.

The underside view of FIG. 7 also shows the recess 150 arranged to cooperate with projection 305 to ensure that the lid is properly located before the fasteners are applied via apertures 110.

FIG. 8 shows an assembled unit 1 comprising a trough 300, two dividers 200 and a lid 100. In practice, a plurality of troughs 300 would be placed in situ before the dividers 200 are added and then the lids 300.

The two dividers 200 in this case define three distinct channels in the body of the trough 300. Each channel can have a defined purpose. For instance, one may carry high or medium voltage power cables, another may carry signalling cable for use by railway systems and the third channel may be leased out to third parties. By segregating the cables in this manner, electrical interference (EMC) may be minimised.

FIG. 9 shows an assembly comprising 2 troughs 1, laid end to end. In reality, many hundreds or even thousands of such troughs may be provided.

Advantageously, embodiments of the invention may be provided to be buried alongside a rail track, or to sit proud of a supporting surface, particularly on an elevated concrete structure. By means of removable dividers, different channels can be created for carrying different services within the trough.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A trunking section for carrying cables, wherein the trunking section comprises mutually interlocking parts allowing two trunking sections to be semi-permanently connected together, wherein the trunking section comprises means to receive at least one divider to partition an interior of the trunking section into at least two longitudinal channels, separated by the at least one divider.

2. The trunking section of claim 1 further comprising a divider.

3. The trunking section of claim 1 further comprising two dividers, arranged to partition the interior of the trunking section into three longitudinal channels.

4. The trunking section of claim 2 wherein the at least one divider is substantially planar and provided with a part which is arranged to have an interference fit with the means to receive at least one divider, and so hold the at least one divider in place.

5. The trunking section of claim 1, wherein a lap joint is formed between adjacent sidewalls of connected trunking sections.

6. The trunking section of claim 1, wherein the trunking section comprises a plurality of feet extending from a lower surface of the trunking section.

7. The trunking section of claim 1, further comprising a lid arranged to close the trunking section.

8. The trunking section of claim 7 wherein the lid is provided with a plurality of fastening apertures to accommodate fasteners to secure the lid to the trunking section.

9. The trunking section of claim 7 wherein the lid is provided with a substantially non-slip surface.

10. The trunking section of claim 1, wherein the trunking section is unitary and formed from a plastics material in an injection moulding process.

11. The trunking section of claim 3, wherein the at least one divider is substantially planar and provided with a part which is arranged to have an interference fit with the means to receive at least one divider, and so hold the at least one divider in place.

12. The trunking section of claim 8, wherein the lid is provided with a substantially non-slip surface.
